(19) United States
(12) Patent Application Publication
(10) Pub. No.: US 2004/0227035 A1
(43) Pub. Date: Nov. 18, 2004

(54) High lift and high strength aerofoil section

(76) Inventor: Adrian Alexander Hubbard, Wolverhampton (GB)

Correspondence Address: ADRIAN ALEXANDER HUBBARD, 39 EGERTON ROAD, BUSHBURY, WOLVERHAMPTON, WV10 8AU, GB

(21) Appl. No.: 10/780,663

(22) Filed: Feb. 19, 2004

(30) Foreign Application Priority Data
Apr. 4, 2003 (GB) GB0307804.5

(51) Int. Cl. B64G 1/22

(52) U.S. Cl. 244/158 R

(57) ABSTRACT

A high lift stepped aerofoil section, incorporating a leading edge 1, trailing edge 3 and a step 2 to provide a higher vertical component in its construction; the aerofoil has greater perceived root thickness giving greater lift through compression 4 on the aerofoil undersurface. The section has high pressure area 5 below the aerofoil and low pressure area 6 above the aerofoil. The aerofoil has much higher strength on all axes than conventional aerofoil sections.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

Conventional aerofoils have usually quite small thickness compared to their chord and it is difficult to provide adequate strength if they are to be efficient, especially in high speed operation. This invention relates to a high lift aerofoil section, incorporating a step, to provide a higher vertical component in its construction; the aerofoil has greater perceived root thickness giving greater lift through compression on the aerofoil undersurface, and much higher strength to the aerofoil on all axes than conventional aerofoil sections.

### BRIEF SUMMARY OF THE INVENTION

According to the present invention there is provided conventional section aerofoil which has a step incorporated within its chord, wherein the step is defined as a substantial difference between the level of the leading edge and the level of the trailing edge of the aerofoil at zero angle of attack. The step is confined around the aerofoil chord center; the length of the step is between one third and two thirds of the aerofoil chord. The depth of the step is between one half of aerofoil thickness and three times aerofoil thickness, depending on the aerofoil application. The step is blended into the aerofoil profile as neatly as possible to create a smooth and aerodynamic airflow over the section. This aerofoil section can be utilised in a number of aerofoil applications including:- aircraft wings, helicopter rotor blades, aircraft propellers, turbofan fan blades etc.

### BRIEF DESCRIPTION OF THE SEVERAL VEIWS OF THE DRAWING

FIG. 1 illustrates a typical stepped section aerofoil.

FIG. 2 illustrates the section of a high aspect ratio aircraft wing incorporating a step.

FIG. 2A illustrates the underside of a high aspect ratio aircraft wing incorporating a step.

FIG. 2B illustrates the front view of a high aspect ratio aircraft wing incorporating a step.

FIG. 3 illustrates the section of a low aspect ratio aircraft wing incorporating a step.

FIG. 3A illustrates the plan view of a low aspect ratio aircraft wing incorporating a step.

FIG. 3B illustrates the front view of a low aspect ratio aircraft wing incorporating a step.

FIG. 4 illustrates the section of a delta aircraft wing incorporating a step.

FIG. 4A illustrates the plan view of a delta aircraft wing incorporating a step.

FIG. 4B illustrates the front view of a delta aircraft wing incorporating a step.

FIG. 5 illustrates the section of a helicopter rotor blade incorporating a step.

FIG. 5A illustrates the plan view of a helicopter rotor blade incorporating a step.

FIG. 6 illustrates the section of an aircraft propeller blade incorporating a step.

FIG. 6A illustrates the front view of aircraft propeller blades incorporating a step.

FIG. 7 illustrates the section of a turbofan fan blade incorporating a step.

FIG. 7A illustrates the front view of a turbofan fan blades incorporating a step.

### DETAILED DESCRIPTION OF THE INVENTION

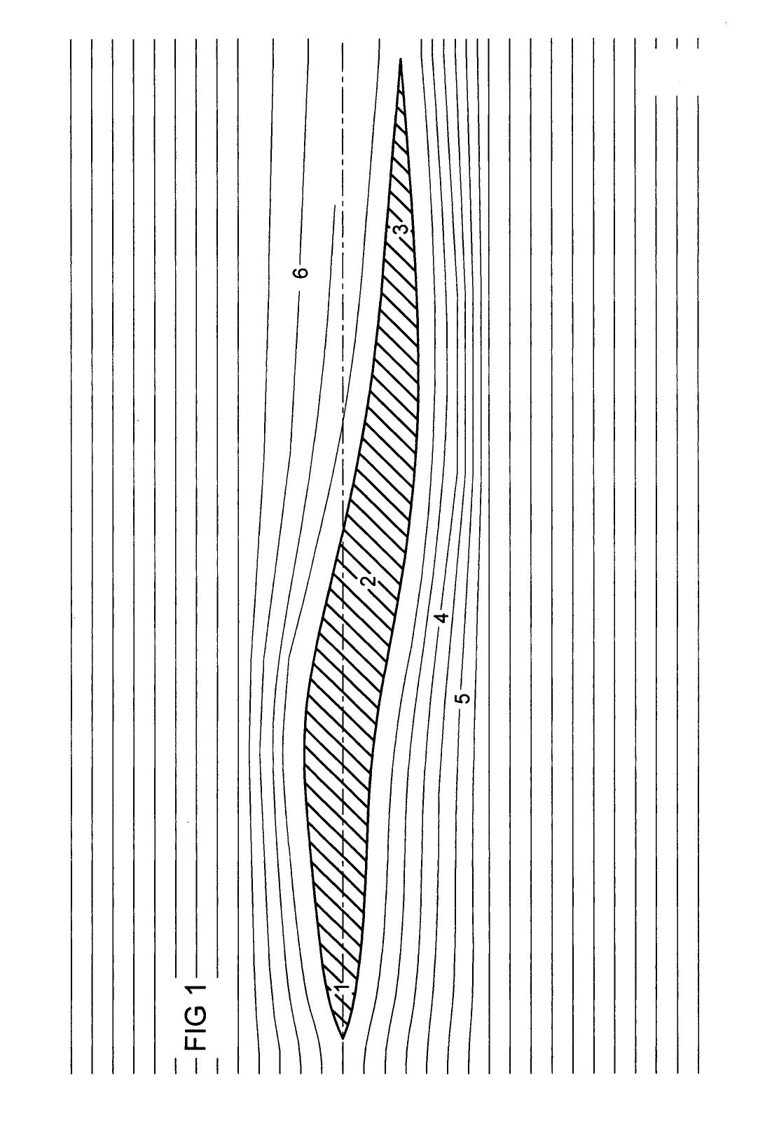

Referring to the drawings the aerofoil has a leading edge 1, a stepped section 2 and a trailing edge 3. The step 2 creates compression 4 on the undersurface of the section giving a high pressure area 5 below the aerofoil; above the aerofoil is a low pressure area 6, see FIG. 1.

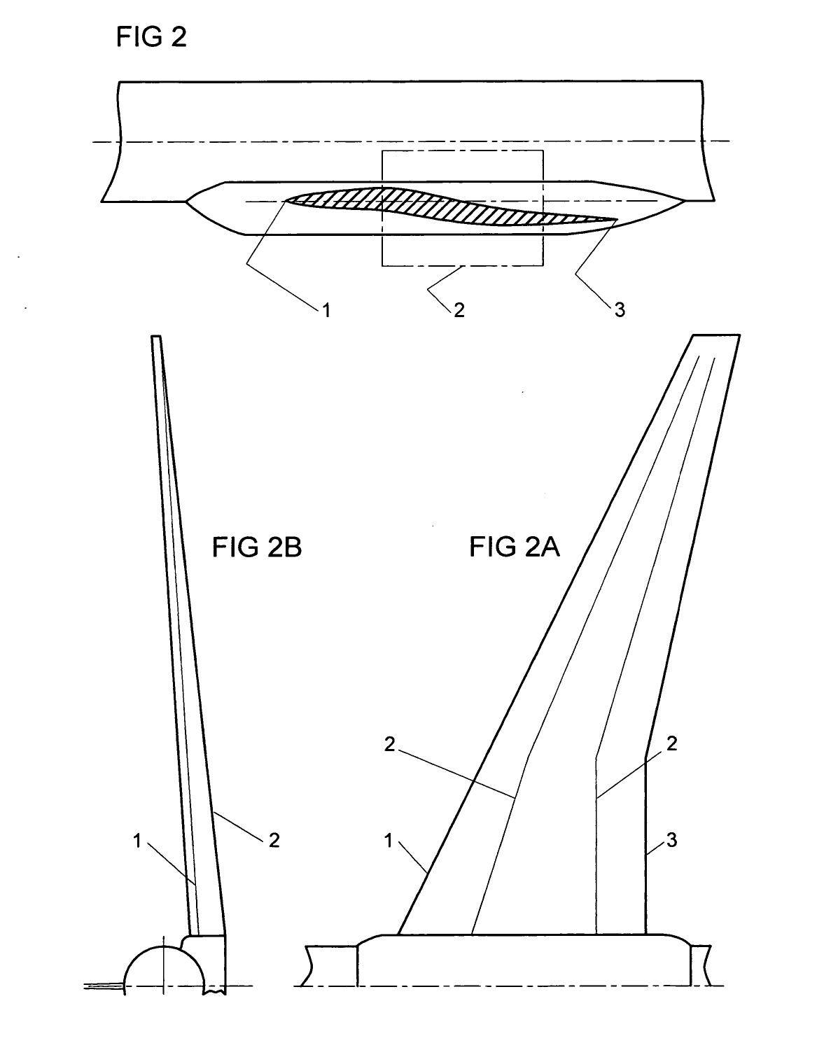

Referring to FIG. 2 the stepped aerofoil is incorporated into a high aspect ratio aircraft wing. The step depth is between half of wing thickness and once wing thickness at the wing root. The step tapers, from maximum depth inboard, to zero depth at the wing tip, see FIGS. 2A and 2B.

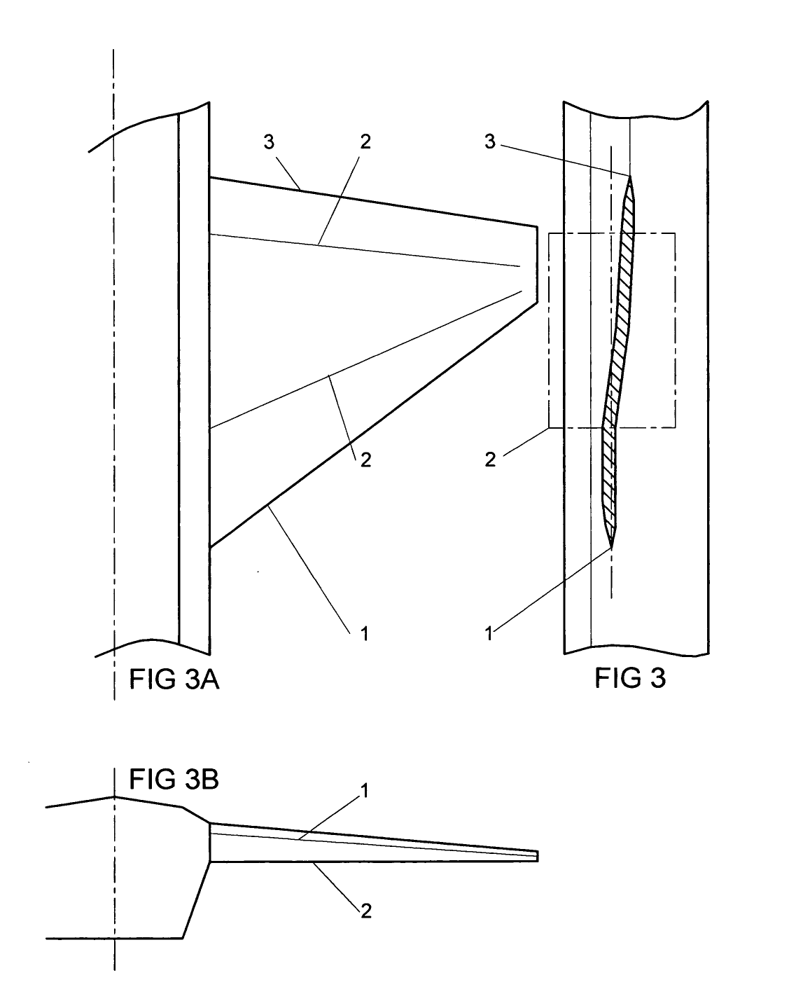

Referring to FIG. 3 the stepped aerofoil is incorporated into a low aspect ratio aircraft wing. The step depth is between once wing thickness and twice wing thickness at the wing root. The step tapers, from maximum depth inboard, to zero depth at the wing tip, see FIGS. 3A and 3B.

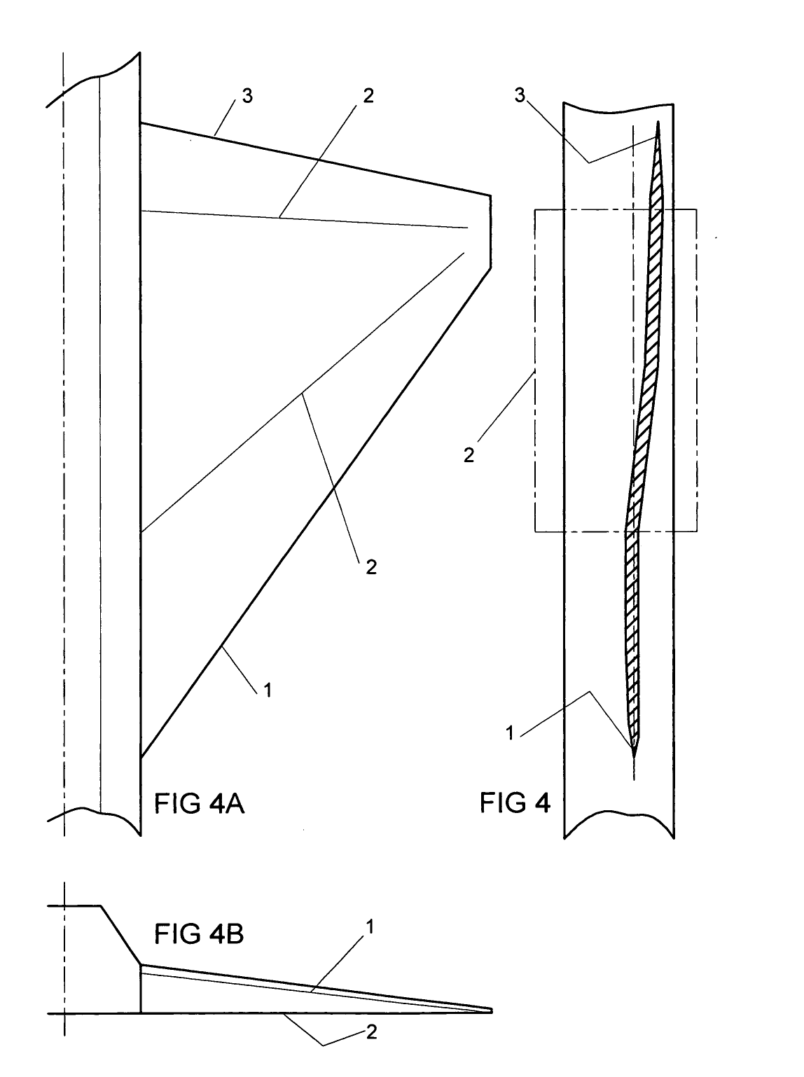

Referring to FIG. 4 the stepped aerofoil is incorporated into a delta aircraft wing. The step depth is between twice wing thickness and three times wing thickness at the wing root. The step tapers, from maximum depth inboard, to zero depth at the wing tip, see FIGS. 4A and 4B.

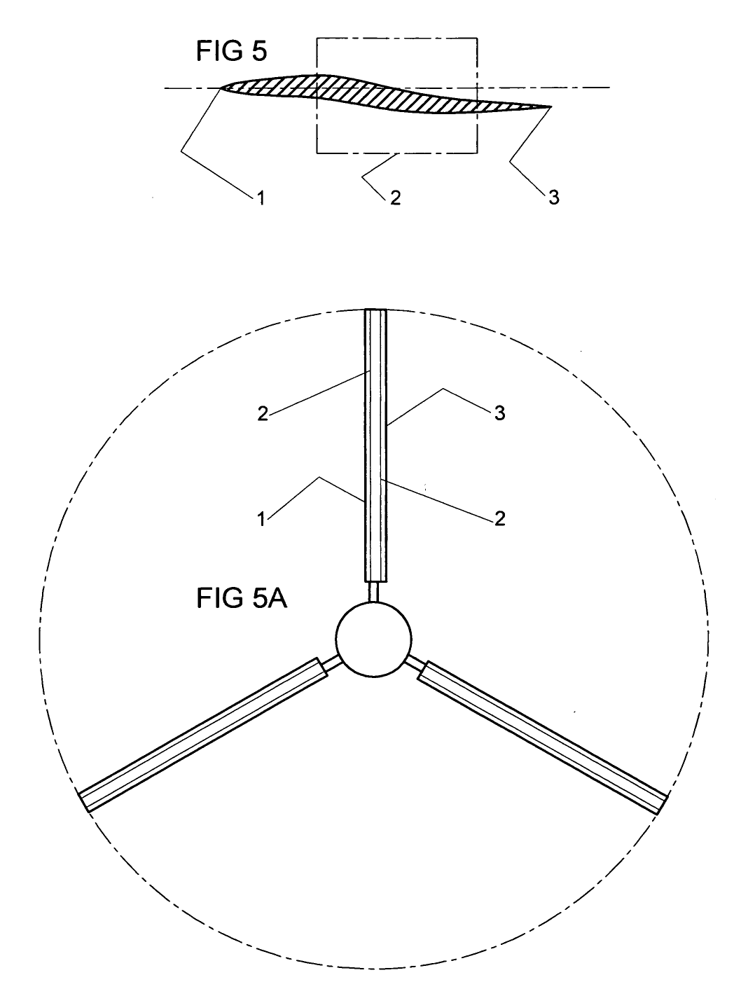

Referring to FIG. 5 the stepped aerofoil is incorporated into a helicopter rotor blade. The step depth is between half of blade thickness and twice blade thickness. The step is not tapered and the depth is constant along the whole blade, see FIG. 5A.

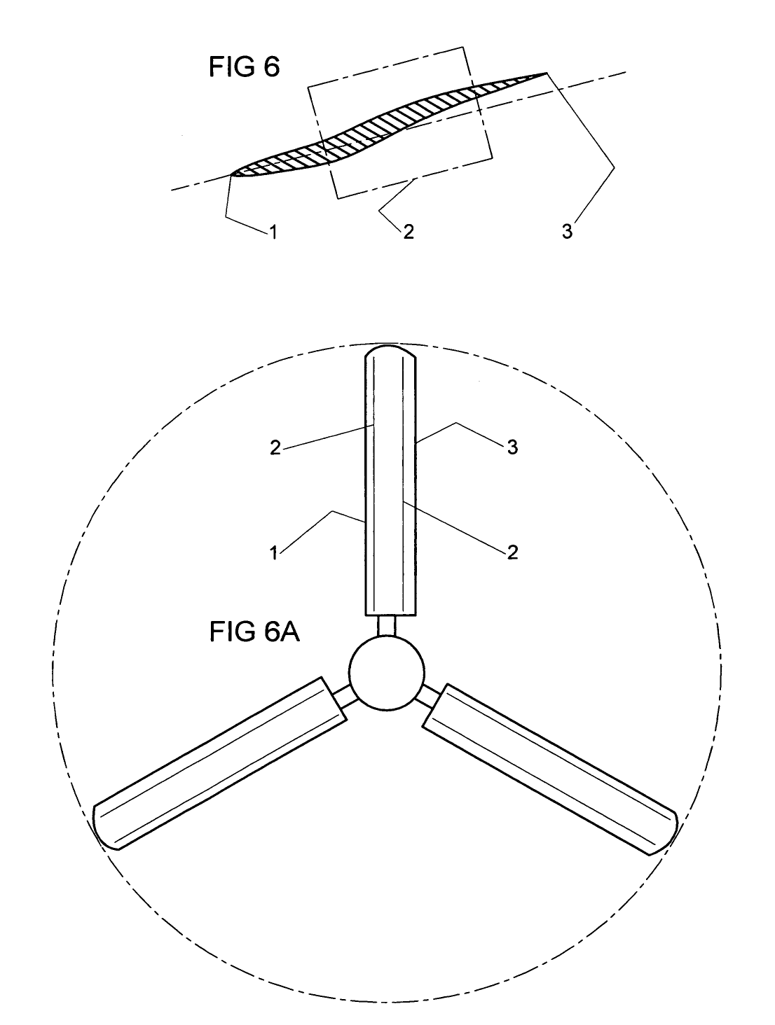

Referring to FIG. 6 the stepped aerofoil is incorporated into an aircraft propeller blade. The step depth is between half of blade thickness and twice blade thickness. The step is not tapered and the depth is constant along the whole blade, see FIG. 6A.

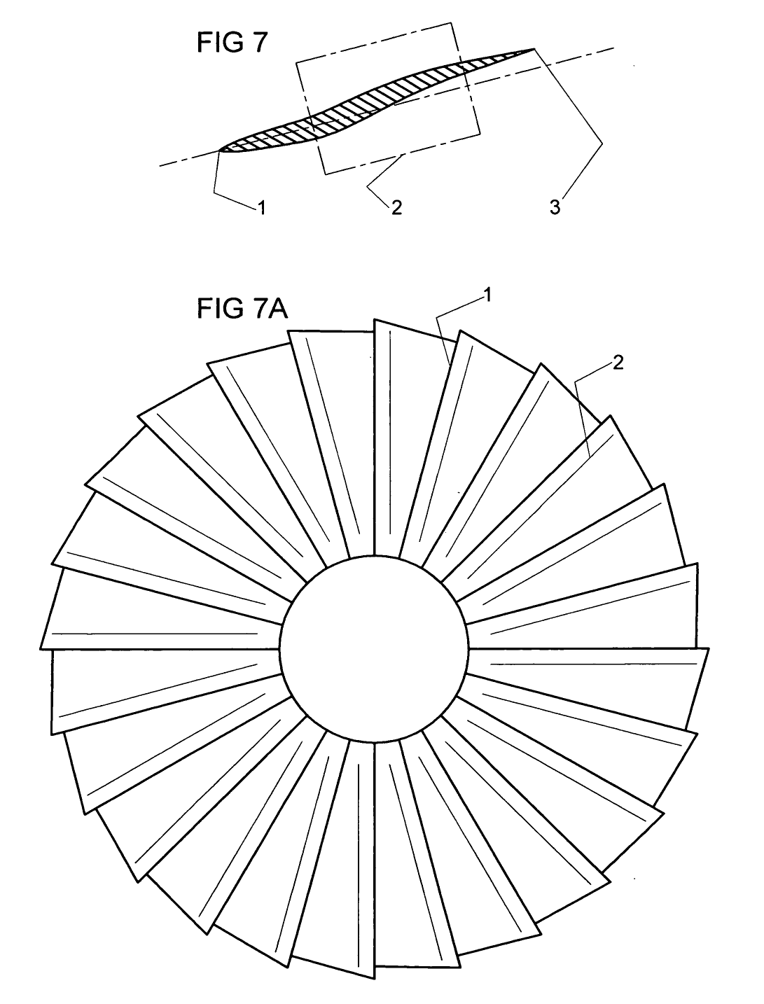

Referring to FIG. 7 the stepped aerofoil is incorporated into a turbofan fan blade. The step depth is between half of blade thickness and twice blade thickness at the blade tip. The step tapers, from maximum depth outboard, to zero depth at the root, see FIG. 7A.

The stepped aerofoil is able to be used for a great many applications which require aerofoils; for lift or downforce, thrust or suction or for turbine blades.

What is claimed is:

1. An aerofoil incorporating a step along its chord, wherein said step is defined as a substantial difference between the level of the leading edge and the level of the trailing edge of said aerofoil at zero angle of attack;
said step is confined around the aerofoil chord center;
said step length is between one third and two thirds of length of said aerofoil chord;
said step provides compression beneath said aerofoil at speed;
said step provides a high pressure area below said aerofoil at speed;
said step provides a low pressure area above said aerofoil at speed;
said step provides said aerofoil with greater perceived thickness;
said step provides said aerofoil with greater strength in all axes than a conventional aerofoil;
said step is blended into said aerofoil profile as neatly as possible to create a smooth and aerodynamic airflow over the section.

2. An aerofoil as claimed in claim 1 manufactured as a high aspect ratio aircraft wing incorporating said step;
said step depth is between half of said wing thickness and once said wing thickness at said wing root;
said step tapers, from maximum depth inboard of said wing, to zero depth at the tip of said wing.

3. An aerofoil as claimed in claim 1 manufactured as a low aspect ratio aircraft wing incorporating said step;
said step depth is between once said wing thickness and twice said wing thickness at said wing root;
said step tapers, from maximum depth inboard of said wing, to zero depth at the tip of said wing.

4. An aerofoil as claimed in claim 1 manufactured as a delta aircraft wing incorporating said step;
said step depth is between twice said wing thickness and three times said wing thickness at said wing root;
said step tapers, from maximum depth inboard of said wing, to zero depth at the tip of said wing.

5. An aerofoil as claimed in claim 1 manufactured as a helicopter rotor blade incorporating said step;
said step depth is between half of said blade thickness and twice said blade thickness along the whole length of said blade.

6. An aerofoil as claimed in claim 1 manufactured as an aircraft propeller blade incorporating said step;
said step depth is between half of said blade thickness and twice said blade thickness along the whole length of said blade.

7. An aerofoil as claimed in claim 1 manufactured as a turbofan fan blade incorporating said step;
said step depth is between half said blade thickness and twice said blade thickness at said blade tip;
said step tapers, from maximum depth at the tip of said blade, to zero depth at the root of said blade.

8. An aerofoil as claimed in claim 1 used for any kind of lift or downforce, thrust or suction or as an impellor.
